(19) United States
(12) Patent Application Publication
(10) Pub. No.: US 2009/0152474 A1
(43) Pub. Date: Jun. 18, 2009

(54) Fluorescent Imaging Device Comprising a Two-Wavelength Variable Lighting Power Light Source

(75) Inventors: Michel Berger, Claix (FR); Alain Gliere, Grenoble (FR); Henri Grateau, Le Gua (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, PARIS (FR)

(21) Appl. No.: 11/989,323

(22) PCT Filed: Jul. 28, 2006
(86) PCT No.: PCT/FR2006/001850

§ 371 Date: Jan. 24, 2008

(30) Foreign Application Priority Data
Aug. 1, 2005 (FR) 0508231

(51) Int. Cl. H05B 33/00

(52) U.S. Cl. 250/484.4

(57) ABSTRACT

A fluorescence imaging device comprises a light source with two wavelengths and variable lighting power. The light source is in the form of a ring and it comprises an alternation of first and second zones respectively able to emit first and second light radiations respectively having distinct first and second wavelengths. Each of the zones further comprises a plurality of elementary light sources controllable independently by selective lighting control means of said elementary sources.

### BACKGROUND OF THE INVENTION

The invention relates to a fluorescence imaging device comprising a light source.

### STATE OF THE ART

Fluorescence imaging devices are in particular used in the medical or biological field. They can thus be used in vivo for performing for example fluorescence imaging of zones marked by a fluorophore coupled with an antibody that fixes itself specifically to unhealthy tissues or organs, for example cancerous tissues. They can also be used to perform in vitro imaging, for example for reading biochips. In this case, the fields concerned are both vegetal and animal biology. For example, a fluorescence imaging device can be implemented to follow the progression of viruses marked with a fluorophore in plants.

Such devices use the fluorescence phenomenon. This phenomenon occurs when a molecule re-emits, in the form of a fluorescent light signal, a part of the energy stored by absorption of a light radiation, called excitation light radiation and originating from a light source such as a laser, an arc lamp or light-emitting diodes (LED). The fluorescence signal is most of the time in the form of an ultraviolet or visible radiation having a larger wavelength that that of the excitation light radiation.

Absorption of energy E2 from excitation light radiation does in fact cause a change in the molecule from a fundamental state to an excited state S2 of very short lifetime (about a nanosecond), with an electron orbital change. Conformational changes and interactions with neighboring molecules then make the molecule change from excited state S2 to a more stable excited state S1, this change corresponding to the internal conversion. Then the molecule changes from excited state S1 to fundamental state S0, releasing a photon having an energy E1 that is smaller than the energy E2 of that initially absorbed by the molecule.

For illustration purposes, a fluorescence imaging device 1 according to the prior art is represented in FIG. 1. It comprises a light source 2 designed to emit at least an excitation light radiation 4 in the direction of a fluorescent sample to be analyzed 3. Light source 2 can also emit other radiations 5 that are not useful in fluorescence imaging. An excitation filter 6 is then arranged between light source 2 and sample 3 so as to only let excitation light radiation 4 pass. When radiation 4 reaches sample 3, the latter re-emits a fluorescence signal 7 that is detected by an imaging system 8. To prevent the detected signal from being disturbed by excitation light radiation 4, an emission filter 9 is arranged between sample 3 and imaging system 8 so as to only let a very small part of excitation light radiation 4 pass.

For samples or operating fields of very small dimensions to be observed, the imaging system is for example a microscope or a binocular magnifier. In this case, a very large number of light sources exist that are suitable for this type of equipment.

For larger operating fields on the other hand, imaging system 8 is generally formed by a 2D detector of CCD camera type with an enlargement suited to the dimensions of the observed field. It is then difficult to find a suitable light source for this type of equipment, in particular to cover an operating field having a diameter larger than 10 cm.

In this type of application for the fluorescence imaging field, there are in fact numerous constraints which fluorescence imaging systems with current light sources are not able to meet. Thus, the power of the excitation light radiation has to be stable in time, and fluorescence imaging device users generally want to be able to use excitation light radiations presenting two distinct wavelength ranges. Moreover, the emission filter has to have a good excitation light radiation cut-off capacity and it is generally desirable to obtain a lighting uniformity of less than +20% on an operating field presenting a diameter of 100 mm lit at a given distance.

### OBJECT OF THE INVENTION

The object of the invention is to provide a fluorescence imaging device remedying the shortcomings of the prior art.

More particularly, the object of the invention is to provide a fluorescence imaging device comprising a light source suitable for operating fields of relatively high dimensions.

According to the invention, this object is achieved by the appended claims.

More particularly, this object is achieved by the fact that the light source is in the form of a ring and by the fact that it comprises an alternation of first and second zones respectively able to emit first and second light radiations respectively having distinct first and second wavelengths, each of the zones comprising a plurality of elementary light sources independently controllable by selective control means of the lighting of said elementary sources.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 illustrates a particular embodiment of a fluorescence imaging device according to the prior art.

FIG. 2 schematically represents a particular embodiment of a fluorescence imaging device according to the invention.

FIG. 3 represents a bottom view of the light source in the form of a ring of the device according to FIG. 2.

FIG. 4 represents a first zone of the light source according to FIG. 3.

FIGS. 5 and 6 illustrate a diffusing white background emitting a fluorescence signal in response to an excitation light radiation, respectively with an emission filter and without an emission filter.

FIG. 7 represents the evolution of the power of the excitation light radiation received by an object versus the diameter of the support and for different distances between the light source and said object, the light source comprising 140 elementary sources emitting a light radiation with a wavelength of about 470 nm.

FIG. 8 represents the evolution of the power of the excitation light radiation received by an object versus the number of activated elementary sources.

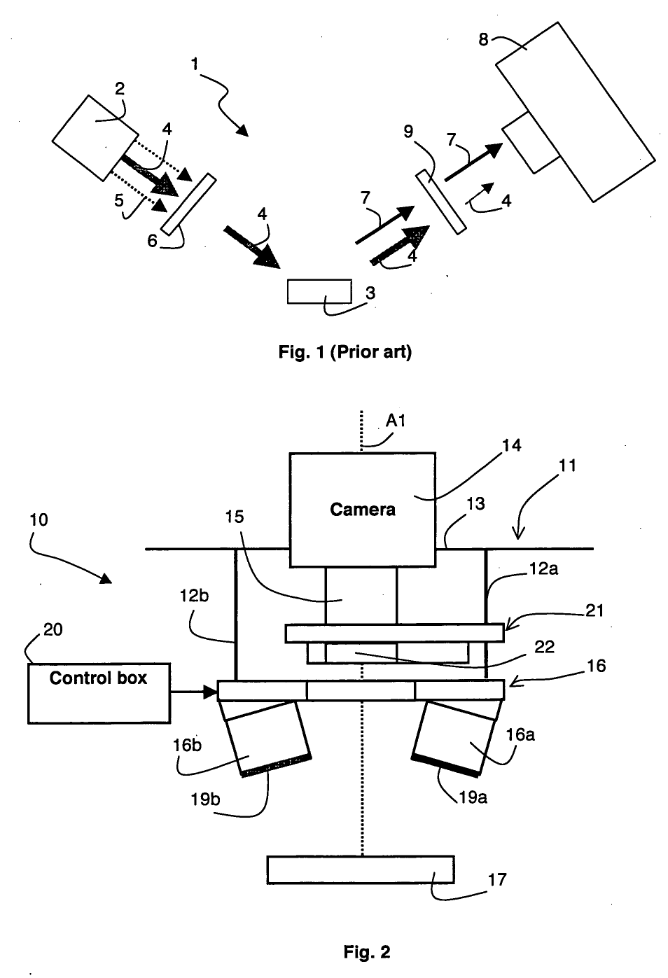

### DESCRIPTION OF PARTICULAR EMBODIMENTS

In a particular embodiment represented in FIG. 2, a fluorescence imaging device 10 comprises a frame 11 equipped with at least two vertical elements 12a and 12b parallel to one another and supporting a horizontal element 13.

A fluorescence signal measuring device 14, such as a CCD camera, is securedly affixed via the top part thereof to the horizontal element 13 of frame 11, and is equipped at the bottom part thereof with a lens 15. A light source 16 in the form of a ring is secured to frame 11 by means of vertical elements 12a and 12b whereto it is fixed. Moreover, different types of lenses can be fitted to measuring device 14.

Light source 16 and measuring system 14 are preferably arranged such as to be coaxial (axis A1 in FIG. 2) and lens 15 of measuring system 14 and light source 16 are directed towards a support 17 designed to receive an object to be analyzed by fluorescence. Support 17 is placed under light source 16. It is more particularly centered on axis A1 common to light source 16 and measuring system 14.

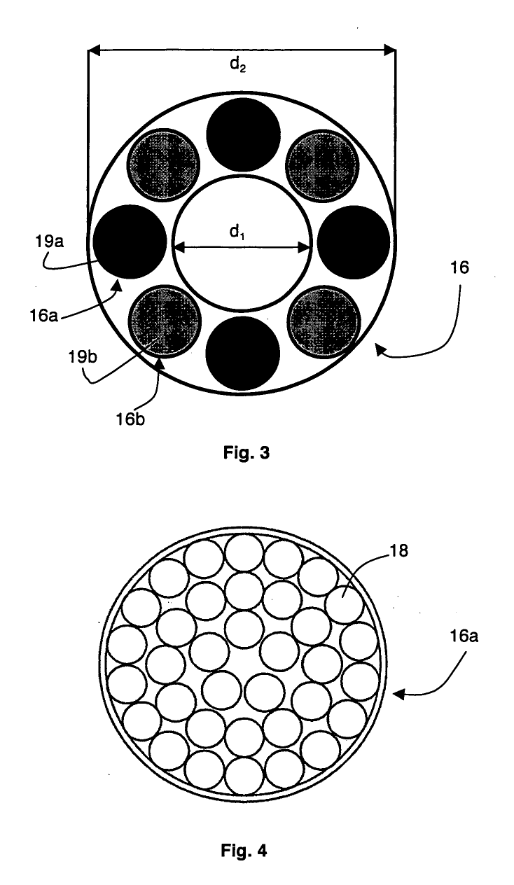

As represented in FIG. 3, light source 16 is in the form of a ring, which presents the advantage of making the lighting very uniform. Preferably, the ring presents an internal diameter d₁ greater than or equal to 100 mm and an external diameter d₂ smaller than or equal to 300 mm. Moreover, light source 16 comprises an alternation of first and second zones 16a and 16b. First and second zones 16a and 16b are respectively able to emit first and second light radiations called excitation light radiation and respectively having distinct first and second wavelengths λ₁ and λ₂. Preferably, first and second excitation wavelengths λ₁ and λ₂ are respectively about 470 nm and about 633 nm. Furthermore, the term “excitation wavelength” must not be interpreted as being limited to a predetermined wavelength value but as a relatively narrow spectral band centered on said wavelength λ₁ or λ₂. When λ¹ and λ² are respectively about 470 nm and about 633 nm, it can be considered that the first zones 16a and the second zones 16b of light source 16 emit excitation radiations, respectively blue and red.

Zones 16a and 16b can be of circular cross-section and can be distributed uniformly in the ring. Moreover, each zone 16a and 16b comprises a plurality of elementary light sources. Thus, as illustrated in FIG. 4, a first zone 16a, of circular cross-section, comprises thirty-five elementary sources 18 distributed uniformly and concentrically inside zone 16a. Elementary sources 18 are for example light-emitting diodes.

Preferably, to obtain first and second zones 16a, 16b respectively able to emit first and second excitation light radiations with respectively distinct first and second wavelengths λ₁ and λ₂, a filter, called an excitation filter, can be associated with each zone 16a and 16b of light source 16. Thus, in FIG. 2, the two zones 16a and 16b represented are provided with excitation filters respectively 19a and 19b and, in FIG. 3, each zone 16a or 16b is provided with a corresponding excitation filter 19a or 19b. Excitation filters 19a and 19b in particular enable the spectral band of the light radiation emitted by the zone with which said filter is associated to be selected. Due to the excitation filters, support 17 is only lit by a predetermined excitation light radiation, i.e. having a predetermined wavelength and selected by the user, disturbance radiations being blocked by the corresponding excitation filter.

Finally, elementary sources 18 can be controlled independently. Control of elementary sources 18 is performed by selective control means of the lighting of said elementary sources. Thus, in FIG. 2, light source 16 is connected to a control box 20 enabling elementary light sources 18 of each zone 16a and 16b to be controlled independently. The control means preferably comprise activation means of first zones 16a or second zones 16b of light source 16, thus enabling the user to choose the excitation wavelength of the excitation radiation that will be emitted from between the two possible wavelengths λ₁ and λ₂. More generally, the user chooses between first and second zones 16a and 16b the type of zones he wants to activate to observe the fluorescence phenomenon. When λ₁ and λ₂ are respectively about 470 nm and about 633 nm, the user chooses to activate either the zones emitting a blue excitation radiation or the zones emitting a red excitation radiation. The control means also preferably comprise means for selecting the number of elementary sources 18 of zones 16a or 16b to be activated. The user can then choose and adjust the power of the excitation light radiation that will be emitted. The lighting power of light source 16 is therefore variable.

The fluorescence imaging system can also comprise an emission filter only letting the fluorescence signal pass. This filter is arranged between support 17 and lens 15. In a particular embodiment, the emission filter can for example comprise at least first and second elementary filters supported by a filter wheel. The elementary emission filters are then chosen such as to be able to respectively block the first and second excitation light radiations emitted by first and second zones 16a and 16b of light source 16. In addition, the filter wheel can be controlled to place the elementary filter corresponding to the excitation light radiation emitted at a given time in front of lens 15. The imaging device represented in FIG. 2 comprises, for illustration purposes, a filter wheel 21 whose axis is offset with respect to axis A1 and that is able to rotate around vertical element 12a. An elementary emission filter 22 is represented in FIG. 2, in position in front of lens 15. The filter wheel enables the emission filter to be changed instantaneously depending on the excitation wavelength chosen by the user. In addition, the filter wheel and the connection between the filter wheel and lens 15 are designed in such a way as to be impervious to any light radiation not passing via the emission filter.

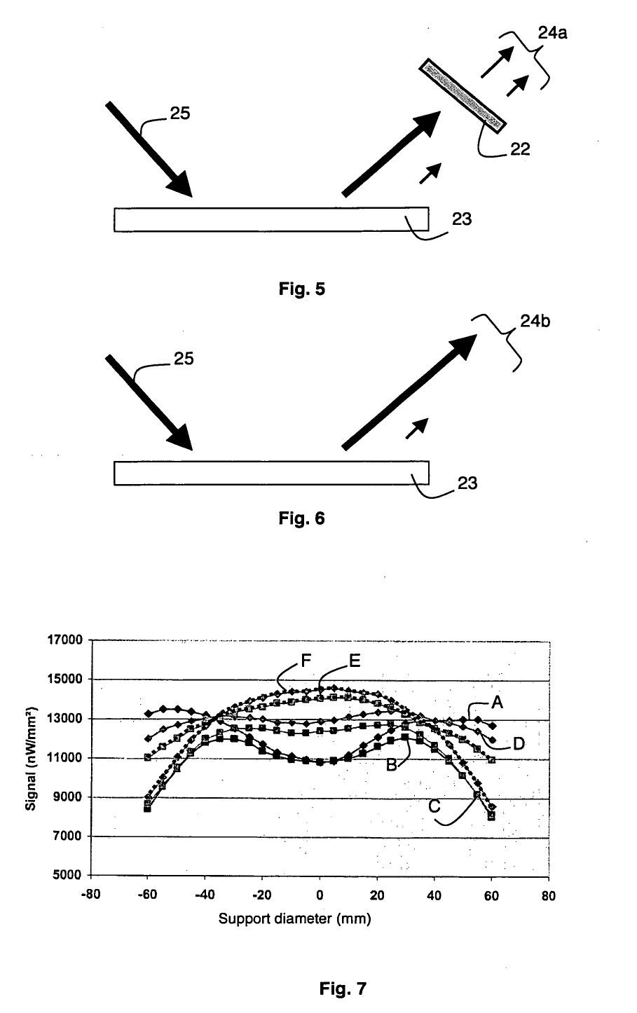

As represented in FIGS. 5 and 6, the cutoff capacity Pc of first and second elementary emission filters 22 used in the imaging device represented in FIG. 2 and respectively associated with blue and red excitation light radiations was measured using a diffusing and weakly fluorescent white background 23 as object to be analyzed. The cutoff capacity Pc corresponds to the ratio between the signal 24a detected by a lens 15 when an elementary filter 22 is placed between the lens and background 23 and the signal 24b detected by the lens when there is no elementary filter 22. The cutoff capacity of the first elementary filter associated with the 470 nm wavelength is 9*10⁻⁶, whereas the cutoff capacity Pc of the second elementary filter associated with the 633 nm wavelength is 5*10⁻⁶.

A measuring device such as the one represented in FIG. 2 can also comprise means for adjusting the distance between light source 16 and support 17. FIG. 7 thus represents the evolution of the power of the excitation light radiation received by an object placed on support 17, along a diameter, for different distances between light source 16 and said object. The light source in this case comprises 140 elementary light sources 18 emitting a blue light radiation.

Measurements were made for distances between the light source and support respectively of 125 mm (curves A and B), 135 mm (curves C and D) and 145 mm (curves E and F) and in two perpendicular directions. It can be observed from curves A to F that the closer the light source is to the object to be analyzed, the more the lighting uniformity drops off in the center. On the contrary, the further it moves away from the object, the more the intensity increases in the center. The same phenomenon is observed when light sources emitting a red light radiation are activated.

The power of an excitation light radiation, either blue or red, received in the center of an operating field with a diameter of 100 mm, and the maximum and minimum powers received by said operating field were measured and set out in the table below for a number of elementary light sources (light-emitting diodes or LED) emitting said radiation varying from 140 to 24 (Tests 1 to 6).

Distance 135 mm-100 mm Field and Blue Excitation Radiation

| | Test 1 | Test 2 | Test 3 | Test 4 | Test 5 | Test 6 |
|---|---|---|---|---|---|---|
| | 140 LED | 120 LED | 96 LED | 72 LED | 48 LED | 24 LED |
| Power | 12865 | 10719 | 8644 | 6569 | 4400 | 2223 |
| in the | | | | | | |
| center in | | | | | | |
| nW/mm² | | | | | | |
| Maximum | 13407 | 11285 | 9139 | 6946 | 4683 | 2365 |
| power in | | | | | | |
| nW/mm² | | | | | | |
| Minimum | 12629 | 10460 | 8503 | 6404 | 4188 | 2068 |
| power in | | | | | | |
| nW/mm² | | | | | | |
| Positive | 4.22 | 5.28 | 5.73 | 5.74 | 6.43 | 6.36 |
| deviation | | | | | | |
| in % | | | | | | |
| Negative | −1.83 | −2.42 | −1.64 | −2.51 | −4.82 | −7.00 |
| deviation | | | | | | |
| in % | | | | | | |

Distance 135 mm-100 mm Field and Red Excitation Radiation

| | Test 1 | Test 2 | Test 3 | Test 4 | Test 5 | Test 6 |
|---|---|---|---|---|---|---|
| | 140 LED | 120 LED | 96 LED | 72 LED | 48 LED | 24 LED |
| Power | 1653 | 1421 | 1144 | 871 | 592 | 317 |
| in the | | | | | | |
| center in | | | | | | |
| nW/mm² | | | | | | |
| Maximum | 1716 | 1484 | 1203 | 920 | 625 | 342 |
| power in | | | | | | |
| nW/mm² | | | | | | |
| Minimum | 1463 | 1263 | 1006 | 753 | 521 | 268 |
| power in | | | | | | |
| nW/mm² | | | | | | |
| Positive | 3.82 | 4.44 | 5.15 | 5.68 | 5.69 | 7.97 |
| deviation | | | | | | |
| in % | | | | | | |
| Negative | −11.46 | −11.11 | −12.05 | −13.54 | −11.92 | −15.28 |
| deviation | | | | | | |
| in % | | | | | | |

The values of power in the center, maximum power and minimum power, for each test, enable a positive deviation and a negative deviation to be determined in the following manner:

Positive deviation=(Maximum power−Power in the center)/Power in the center

Negative deviation=(Minimum power−Power in the center)/Power in the center.

These two deviations reflect the lighting uniformity ± in percentage.

It can thus be observed from the table above that, for all the tests, the lighting uniformity ± is less than 20% and that the positive and negative deviations increase when the number of elementary light sources decreases. Furthermore, whether it be with a blue excitation radiation or a red excitation radiation, it is possible to reduce the useful field to improve the uniformity. By going for example to a diameter of 80 mmn, a lighting uniformity ± of less than 10% is achieved.

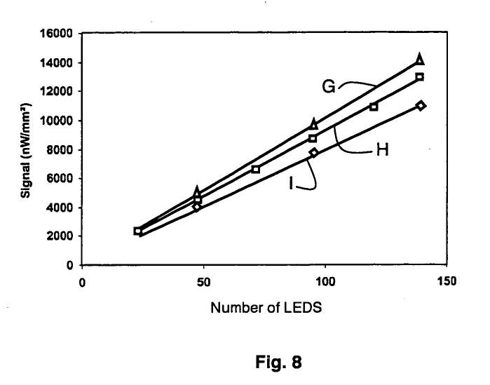

FIG. 8 further illustrates the evolution of the power of the excitation radiation received by an object versus the number of elementary light sources (LEDs emitting at 470 nm) activated for a distance between light source 16 and said object of respectively 145 mm (curve G), 135 mm (curve H) and 125 mm (curve I). In all three cases, the lighting power varies linearly with the number of LEDs lit.

A fluorescence imaging device according to the invention presents the advantage of comprising an annular light source, with two distinct wavelengths called excitation wavelengths. Such a light source more particularly enables a user to choose the excitation wavelength enabling the fluorescence phenomenon to be observed, and to adjust and vary the lighting power if required. The assembly formed by these elements then enables a light source to be obtained, and more particularly constitutes a fluorescence imaging device that is particularly suited to operating fields of relatively high dimensions. It also enables a uniform lighting to be obtained over a given operating field and this lighting remains uniform when the lighting power varies and if the distance between the light source and the object to be analyzed remains within a given range.

1. A fluorescence imaging device comprising at least one light source wherein the light source is in the form of a ring and comprises an alternation of first zones and second zones respectively able to emit first light radiation and second light radiation respectively having distinct first wavelength and second wavelengths, each of the zones comprising a plurality of elementary light sources able to be controlled independently by selective lighting control means of said elementary sources.

2. The device according to claim 1, characterized wherein the selective lighting control means comprise means for activating the first zones or the second zones.

3. The device according to claim 2, wherein the selective lighting control means comprise means for selecting a number of elementary sources of said zones to be activated.

4. The device according to claim 1, wherein the elementary light sources are formed by light-emitting diodes.

5. The device according to claim 1, wherein the ring forming the light source presents an internal diameter greater than or equal to 100 mm and an external diameter smaller than or equal to 300 mm.

6. The device according to claim 1, wherein the first zones and the second zones are distributed uniformly in the ring.

7. The device according to claim 1, wherein a filter is associated with each zone of the light source.

8. The device according to claim 1, wherein it comprises at least:
a support on which an object to be analyzed is placed
and a measuring device of a signal emitted by the object in response to a light radiation emitted by the light source and comprising a lens.

9. The device according to claim 8, wherein the ring forming the light source and the lens of the measuring device are coaxial.

10. The device according to claim 8, wherein at least an emission filter only letting the signal emitted by the object pass is placed between the support and the lens.

11. The device according to claim 10, wherein the emission filter comprises at least a first elementary filter and a second elementary filter supported by a filter wheel and able to respectively block the first light radiation and the second light radiation emitted by the light source, and wherein control means of said wheel enable the elementary filter corresponding to the light radiation emitted to be placed in front of the lens.
